(19) United States
(12) Patent Application Publication
(10) Pub. No.: US 2002/0002624 A1
(43) Pub. Date: Jan. 3, 2002

(54) Method for transmitting a message, and gateway

(76) Inventors: Rudiger Hausmann, Penzberg (DE); Gero Offer, Gilching (DE)

Correspondence Address: Lerner And Greenberg P A, Post Office Box 2480, Hollywood, FL, 33022-2480, US

(21) Appl. No.: 09/784,765

(22) Filed: Feb. 15, 2001

(30) Foreign Application Priority Data
Feb. 15, 2000 (EP) 00103074.1

(51) Int. Cl. G06F 15/16

(52) U.S. Cl. 709/246; 709/249

(57) ABSTRACT

A message is transmitted to a terminal in a data communications network, in particular an IP network, or from the data communications network to a telecommunications network, in particular a mobile radio network. The message format is converted, prior to its transmission, in accordance with a applicable conversion and processing rule set from a set of conversion and processing rules which are stored in a rule database. Optionally, supplementary information is added and/or the message content is reduced by predetermined parts.

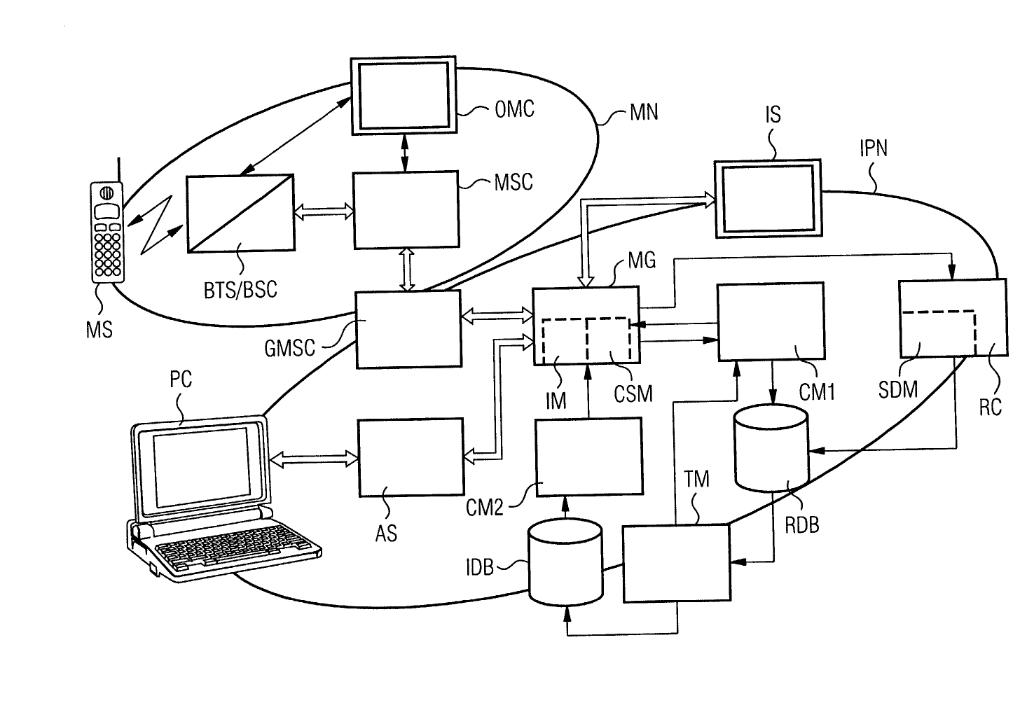

### BACKGROUND OF THE INVENTION

### FIELD OF THE INVENTION

The invention lies in the communications field. More specifically, the invention relates to a method for transmitting a message in a data communications network, or from such a network to a telecommunications network. The message is transmitted to a terminal in a data communications network, in particular an IP network, or from the data communications network to a telecommunications network, in particular a mobile radio network. The message format is converted in accordance with at least one predetermined conversion rule in a gateway. The invention also pertains to a corresponding gateway.

Data and telecommunications networks are being linked to an ever greater extent. Firstly, the manufacturers of mobile radios and systems and the operators of mobile radio networks are becoming increasingly interested in offering mobile radio technology users access to data communications networks—in particular the Internet—in as useful and simple a manner as possible and, secondly, the operators of services on the Internet are interested in being able to directly address their product to the large number of communications terminal users in addition to data terminal users.

In the course of this linking process, so-called “media gateways” are being increasingly established, and they carry out the necessary adaptation processes to message and file formats for the respective terminals and matching to the specific receivers—in particular conversion from HTML (hypertext markup language) files to the WML (wireless markup language) format, or vice versa. It is noted, in this context, that current mobile radio terminals are unable to process the HTML format but instead operate in the WAP (wireless application protocol) environment using the language WML.

Fixed, predetermined conversion rules are implemented in gateways such as this, by means of which the message content of the appropriate files is changed to a format which is optimized and/or can be used at the terminal end, in order to allow the message to be received and evaluated at the terminal at all, or to shorten the transmission time.

The functionality of these media gateways is, however, still limited to the originally implemented conversion function.

### SUMMARY OF THE INVENTION

The object of the present invention is to provide a message transmission method and a corresponding gateway which overcome the above-noted deficiencies and disadvantages of the prior art devices and methods of this general kind, and which provides for an improved method for transmitting a message in a data communications network, or from such a network to a telecommunications network with a functionality which is considerably extended, or can be considerably extended, and for a corresponding gateway.

With the above and other objects in view there is provided, in accordance with the invention, a method of transmitting a message to a terminal in a data communications network, in particular an IP network, or from the data communications network to a telecommunications network, in particular a mobile radio network, with the message format being converted in accordance with at least one predetermined conversion rule in a gateway. The method of transmitting the message comprises the following method steps:

prior to a start of a transmission of a message, setting up a connection between a gateway and a rule database having stored therein a set of conversion and processing rules;

starting a selection routine for defining an applicable conversion and processing rule set from the set of conversion and processing rules for conversion of the message format;

forming a conversion control signal from the conversion and processing rule set;

buffer-storing the conversion and processing rule set or the control signal in the gateway; and

converting the message format in accordance with the conversion rule in the gateway.

The invention includes the fundamental idea of creating the capability for flexible processing of messages to be transmitted in the gateway, by access to a suitably associated and constructed database. Furthermore, the invention includes the idea of processing a selection routine for this purpose before message transmission—for example when setting up a session—in the course of which selection routine a set of conversion/processing rules which are applicable to the respective constellation is obtained with differentiated access to this rule database. Finally, the invention includes the idea of buffer-storing this rule set and/or a control signal derived from it for the processing of the message in the gateway.

The processing of the message is, in particular, a format conversion—which is known per se but can be selected in a specific manner in the context of the invention—for example conversion from the HTML format to the WML format for transmitting messages from the Internet to a mobile radio network. A further conversion process which can be actuated comprises translation into a different language. Such language conversion can be actuated, in particular, as the result of logic processing of a source IP address and the dialing-in point when this results in the user who is dialing in being identified as being a foreigner and it is possible to form an association with his (supposed) mother tongue. A further useful conversion for a range of applications is the conversion of an addressed IP address, for example for the purposes of relaying, for server bypassing or in conjunction with the calling of a Web Call & Session Center.

A further major option for processing the message to be transmitted is to add supplementary information to it. This relates in particular to advertising information which, in particular, is included in a portal site produced on the basis of user profiles, or overlaid as an advertising banner. Further useful supplementary information which may be added in the course of processing the message includes tariff information and handling information, for example info-push information.

Finally, in the course of processing, it is also possible to mask out specific message parts (for example advertising components), depending on the user profile, up to “masking out” or inhibiting the transmission of an entire site (for example sites whose contents are pornographic or violent).

The selection function expediently includes the execution of a logic processing action on a data record comprising personal user data (for example age, marital status, fields of interest, consumer behavior data, etc.) and/or the data or telecommunications network address of the terminal and/or the identification of a dialing-in point or the geographical location of the terminal and/or the data network address of the message source and/or time data (calendar or time of day) and/or the identification of the carrier medium or transmission path intended for transmission of the message, and/or other selection criteria, in particular criteria predetermined by the gateway operator.

While the conversion and processing rules mentioned above are expediently stored in a first memory or memory area in the gateway, a second memory or memory area is advantageously used for storing predetermined selection data records which are structured on the basis of practical experience in the use of the data network, or on the basis of requirements from providers, service providers, or user groups. Such a selection data record is expediently addressed, when setting up a connection, as a function of a start condition (which is normally included in the selection data).

The supplementary information mentioned above is called up from one or more supplementary information memory or memories, by means of which the gateway is connected as appropriate to the applicable conversion and processing rule set, at least at the time when the message is processed.

The setting up of the media gateway, that is to say of the server or computer system entrusted with the conversion and processing tasks, takes place essentially on the basis of the method and function aspects referred to above. In addition to the memory facilities which have been mentioned, the gateway has, in particular, a number of connection means which are used firstly for producing a connection to the rule database, and secondly for connection to the supplementary information memory, together with control means for starting and processing the selection routine, and converter means for forming a conversion control signal from the selected conversion and processing rule set.

With the above and other objects in view there is also provided, in accordance with the invention, a gateway for converting the format of a message before transmission to a terminal in a data communications network, in particular an IP network, or from the data communications network to a telecommunications network, in particular a mobile radio network, in accordance with at least one predetermined conversion rule. The gateway comprises:

a first connection device for producing a connection to a rule database;

a control device connected to the first connection device, the control device being programmed to start and process a selection routine for defining an applicable conversion and processing rule set from a set of conversion and processing rules (which are stored in the rule database) for conversion of the message format and optionally for adding supplementary information and optionally for reducing the message by predetermined parts;

a conversion device connected to the control device for forming a conversion control signal from the conversion and processing rule set; and

a memory device connected to the conversion device for storing one of the conversion and processing rule set and the conversion control signal.

Other features which are considered as characteristic for the invention are set forth in the appended claims.

Although the invention is illustrated and described herein as embodied in a method for transmitting a message, and a gateway, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE is a schematic illustration in the form of a functional block diagram of an exemplary embodiment of a system for carrying out the method according to the invention in an IP network which is linked to a mobile radio network.

### DESCRIPTION OF THE PREFERRED EMBODIMENT

Referring now to the sole FIGURE of the drawing in detail, it should first be noted that the assumed layout of the mobile radio network is known per se and it will thus not be explained in any more detail here. A mobile station MS is connected by radio to a base station BTS/BSC, which covers a radio area of one cell of the mobile radio network MN. A mobile switching center MSC forms a switching node in the mobile radio network MN, with which the base station BTS/BSC is associated and which, for its part, is connected to a gateway mobile switching center GMSC for producing a link to the IP network IPN; (in packet-oriented mobile radio networks (GPRS, UMTS), this link is produced by a gateway service node (GSN). An operation and maintenance center OMC controls and monitors the ongoing network operation of the mobile radio network MN and controls subscribers, terminals, invoices etc. The operation and maintenance center OMC is further used for network configuration and performance management, and finally, for security management and maintenance. The layout of the mobile radio network MN is illustrated in an incomplete form since it does not illustrate the normally associated databanks, for example for subscriber identification and authentication, and for equipment registration. These features, however, are well understood to form an integral part of the system and are therefore not illustrated for purposes of clarity.

The layout of the IP network IPN is sketched in an even more simplified form showing—apart from the already mentioned gateway mobile switching center GMSC—only one access server AS via which a laptop PC has access to the network, and an information server IS via which a specific range of messages is controlled and is prepared for transmission. Furthermore, a media gateway MG is shown, which is connected between the information server IS on the one hand, and the gateway mobile switching center GMSC and access server AS on the other hand.

The media gateway MG is connected to a rule database RDB via a first connection device CM1 for data and via a routine sequence controller RC for control. The routine sequence controller has a selection data memory SDM. The rule database RDB is for its part connected to the input of a converter device TM, which is connected on the output side via the first connection device CM1 to the media gateway, to be precise to an internal control data buffer store CSM there. Furthermore, the converter device TM is connected on the output side to a supplementary information database IDB, which, for its part, is connected via a second connection device CM2 to the media gateway, to be precise to a supplementary information buffer store IM there.

Two specific examples will be used in the following text to explain how this configuration operates.

First of all, it is assumed that a user of the mobile radio network MN uses his mobile station MS, which is a WAP (Wireless Application Protocol)—compatible mobile telephone, while traveling on business abroad to ask an online broker (who handles stock trading for the user within his own country) for the present stock prices of specific shares. The online broker can access the information server IS for the latest stock prices (“intraday” rates) of important shares for the customers. As a particular service, the online broker offers time conversion between the time at the trading center and the local time where a user who is asking for the prices is located. Appropriate conversion is carried out at the media gateway MG on the basis of a signal which is received from the mobile radio network MN via the gateway mobile switching center GMSC and presents the present location of the user of the mobile station MS. Such a signal is in any case available in the cellular mobile radio network in conjunction with the present allocation of a base station BTS/BSC to the mobile station MS and, via the operation and maintenance center OMC, this information can be handed over via the gateway mobile switching center to the media gateway in the IP network IPN. Furthermore, when the user makes his request, his identification code is, of course, transmitted to the media gateway MG (and, of course, also on to the information server IS).

When the connection is set up between the mobile station MS and the information server IS of the online broker, a connection is at the same time produced between the media gateway MG and the rule database RDB, and the routine sequence controller RC is activated in order to carry out a processing rule check. During this process, the user's identification code is used firstly to call up a user profile which may, for example, contain the share certificate identification numbers of those shares which the user holds in his depository. Furthermore, the processing of the routine includes identification of the terminal used for the request as a mobile telephone, as well as the signal which identifies the location.

A conversion and processing rule set which is applicable to the present request is then formed in the rule database RDB from the large number of stored conversion and processing rules. This describes, in particular, filtering of the rate table provided by the online broker with the share selection data (WPKN of the shares held by the user), transmission of the message in the language WML which is “legible” by the mobile telephone, and time conversion to the local time where the user is located.

This conversion and processing rule set is converted in the converter device TM into a corresponding control signal sequence which is transmitted to the media gateway MG, where it is buffer-stored in the control data buffer store CSM. Optionally, the control signal sequence output by the converter device TM can be used for addressing the supplementary information database IDB. From there, for example on the basis of that part of the control signal sequence which identifies the location of the user, local advertising information can be entered in the supplementary information buffer store IM of the media gateway via the second connection device CM2.

Once the online broker's information server has recorded the request from the user and has checked his access authorization and the subject matter of the request, the Internet site which covers the rate table is released and is subjected in the media gateway to the conversion and processing outlined above, on the basis of the data stored in the control data buffer store CSM and in the supplementary information buffer store IM, and is finally transmitted, as a WML message, which comprises the latest rate, related to local time, of the shares held by the user as well as local advertising information, to the mobile station MS where it is indicated on the display.

A second example is based on the assumption that an Internet user who is interested in bond investments would like to make use of the information offered by the online broker via his laptop PC, without having to be already registered as a customer with this online broker. He dials the broker's network address, at which point a connection to the broker's information server IS is produced via the access server AS. The media gateway is included in the connection in this case as well and receives, at least, information relating to the dialing-in node of the user. Further relevant information can be derived from the fact that the user did not enter a customer number or an identification code when setting up the connection.

The selection routine which is started with activation of the routine sequence controller RC when the connection is set up is thus based on a less comprehensive selection data record, but equally allows sensible determination of a relevant conversion and processing rule set from the set of conversion and processing rules stored in the rule database. The rule set which is appropriate here describes in particular the provision of a portal site containing factual information and advertising information processed in an addressable manner, and the overlaying of advertising banners of local service providers from the geographical region of the dialing-in node of the user.

As in the previous example, a control signal sequence which reflects the applicable rule data record is buffer-stored in the control data buffer store CSM of the media gateway MG, the supplementary information database IDB is addressed by means of the control signal sequence, and the supplementary information (portal site and advertising banner) which is read is transferred to the supplementary information buffer store IM. The message provided from the information server IS in the normal Internet HTML format does not need to be subjected to any format conversion in this case—contrary to the situation with a mobile radio terminal. If it becomes evident from the identification of the dialing-in node that the user is located abroad, language conversion may, however, need to be carried out if this service is implemented in the media gateway. Otherwise, after presentation of the portal site and along with overlaying of the advertising banner selected as supplementary information, the message is displayed on the user's laptop PC.

It is understood that the implementation of the invention is not limited to the exemplary embodiments, but it is likewise feasible in a large number of modifications, which lie within the scope of those skilled in the pertinent art.

In particular, this can also refer to the transmission of video picture sequences, especially live recordings as well, with the actual message having supplementary information added to it (in addition to portal sites, advertising banners or the like). The opening of so-called chat windows for online communication with other users in the course of transmission of a message should also be regarded as being within the scope of the invention.

We claim:

1. A method of transmitting a message having a given message format, which comprises:
prior to a start of a transmission of a message, setting up a connection between a gateway and a rule database having stored therein a set of conversion and processing rules;
starting a selection routine for defining an applicable conversion and processing rule set from the set of conversion and processing rules for conversion of the message format;
forming a conversion control signal from the conversion and processing rule set;
buffer-storing the conversion and processing rule set or the control signal in the gateway; and
converting the message format in accordance with the conversion rule in the gateway.

2. The method according to claim 1, which comprises transmitting the message to a terminal in a data communications network.

3. The method according to claim 2, which comprises transmitting the message to an IP network.

4. The method according to claim 1, which comprises transmitting the message from a data communications network to a telecommunications network.

5. The method according to claim 4, which comprises transmitting the message to a mobile radio network.

6. The method according to claim 2, which comprises performing the steps of setting up and starting the selection routing when a session is being set up in the data communications network.

7. The method according to claim 1, wherein the rule database has stored therein sets of organized conversion and processing rules for linked execution of conversion and processing steps.

8. The method according to claim 1, which comprises processing the selection routine with a selection data record including data selected from the group consisting of:
user data;
a data communications network or telecommunications network address of the terminal;
an identification of a dialing-in point or a geographical dialing-in location into the data communications network, or of the location of a terminal in the telecommunications network;
a data communications network address of the message source;
real-time data;
an identification of one of a number of permissible carrier media or transmission paths to the terminal; and
general selection criteria, and specific selection criteria predetermined by an operator of the gateway.

9. The method according to claim 8, wherein the step of processing the selection routine comprises calling up an individual user profile based on at least one of the user data and the data communications network or telecommunications network address of the terminal.

10. The method according to claim 1, wherein the converting step comprises one of translating into a different language and adding supplementary information in a different language.

11. The method according to claim 2, wherein the converting step comprises converting an addressed IP address involved with the transmission process in the data communications network.

12. The method according to claim 11, wherein the converting step comprises converting the IP address in dependence on a relaying condition set on the terminal or on a server.

13. The method according to claim 1, wherein the converting step comprises converting at least a part of the message between HTML format and WML format.

14. The method according to claim 1, which comprises, in addition to converting the message format, adding supplementary information or reducing the message by predetermined parts.

15. The method according to claim 14, wherein the supplementary information and the predetermined parts of the message is advertising information.

16. The method according to claim 15, wherein the supplementary information is included in a portal site produced on a user-related basis and presented before the transmission of the message, is overlaid as an advertising banner, are video picture sequences or chat windows for on-line communication.

17. The method according to claim 14, wherein the supplementary information is selected from the group consisting of tariff information and info-push information.

18. The method according to claim 14, wherein the step of reducing by predetermined parts comprises essentially completely inhibiting transmission of an entire message.

19. The method according to claim 14, wherein the step of reducing by predetermined parts comprises inhibiting a transmission of a complete IP network site.

20. A gateway for converting a message format, comprising:
a first connection device for producing a connection to a rule database;
a control device connected to said first connection device, said control device being programmed to start and process a selection routine for defining an applicable conversion and processing rule set from a set of conversion and processing rules (which are stored in the rule database) for conversion of the message format and optionally for adding supplementary information and optionally for reducing the message by predetermined parts;
a conversion device connected to said control device for forming a conversion control signal from the conversion and processing rule set; and
a memory device connected to said conversion device for storing one of the conversion and processing rule set and the conversion control signal.

21. The gateway according to claim 20, wherein said memory device is a first memory device and a second memory device is configured to store at least one selection data record for processing the selection routine.

22. The gateway according to claim 20, wherein said connection device is a first connection device and including a second connection device for connection to a device selected from the group consisting of a supplementary information memory, a video signal source, and a terminal communication path.

23. In combination with a data communications network and a telecommunications network, the gateway according to claim 20 adapted to convert a message prior to a transmission thereof between the data communications network and the telecommunications network.

24. In combination with a data communications network, the gateway according to claim 20 adapted to convert a message prior to a transmission thereof from the data communications network to a terminal in the data communications network.
